(19) United States
(12) Patent Application Publication
(10) Pub. No.: US 2007/0168312 A1
(43) Pub. Date: Jul. 19, 2007

(54) User control points in a network environment

(75) Inventor: Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/578,067

(22) PCT Filed: Oct. 28, 2004
(86) PCT No.: PCT/IB04/52233

§ 371 Date: May 2, 2006

(30) Foreign Application Priority Data
Nov. 5, 2003 (EP) 03104086.8

(51) Int. Cl. G06F 17/30

(52) U.S. Cl. 707/1

(57) ABSTRACT

The present invention relates to a method, apparatus, computer program product and computer program element for creating a control point associated with a user in a computing environment having a network connectivity model, a method apparatus, computer program product and computer program element for accessing services provided by a device in such an environment. A control point is created for a user including a control point identity (step 46) based on a public key of the user and control point functionalities (step 48). The control point is stored (step 50) such that the user can operate any device from any physical entity or point of access where the control point is activated.

The present invention generally relates to the field of security in a network environment. The present invention more particularly relates to a method, apparatus, computer program product and computer program element for creating a control point associated with a user in a computing environment having a network connectivity model, a method, apparatus, computer program product and computer program element for accessing services provided by a device in such an environment, as well as to a network of computing devices including such apparatuses.

In the field of networking the connectivity model used is often UPnP (Universal Plug and Play). This standard defines entities such as control points, devices and security consoles. A device is here a physical entity that has a set of services it offers to different elements of the network, where a security console determines the rights for such elements regarding such a device. A control point can then be allowed to use the services of the device in case the security console has granted the control point access rights. In this environment a control point can be provided in the same or in a different physical entity as the device is provided in. The same applies to the security console, which can be provided in the same entity as the physical device. It can also be provided for different devices. These types of entities are described in more detail in “Home Network Security” by Carl M. Ellison, Intel Technical Journal, Vol. 6, Issue 4, page 37-48, Nov. 15, 2002.

There is however a problem associated with the known type of control points and that is that they are device dependent. This means that a control point is associated with a first device or machine connected in a network, which is trying to get access to a service in a second device. There can however be a need for allowing different types of rights in relation to devices in dependence of the person wanting to access the device. This is today not possible in the UPnP environment. All persons trying to get access to a device via a control point will then have the same rights, which might not be in the interest of the owner of the device to which a user is getting access.

There is therefore a need for a solution allowing users different rights independently of the point of access and without having to change the connectivity model used.

It is an object of the present invention to allow different rights to users in relation to devices in a computing environment having a networking connectivity model independently of the point of access and without having to change the connectivity model used.

According to a first aspect of the present invention, this object is achieved by a method of creating a control point associated with a user for a computing environment having a networking connectivity model and comprising the steps of:

generating a control point identity for the user based on a public key associated with the user,

providing at least basic control point functionalities, and

storing the control point identity and the functionalities as a control point, such that the user can operate any device he is allowed to in the computing environment from any physical entity where the control point is enabled.

According to a second aspect of the invention, this object is also achieved by a

method of accessing services provided by a device in a computing environment having a networking connectivity model and comprising the steps of:

identifying a user wanting to access services at a point of access for the user to the computing environment by using a control point identifier,

determining if there is a control point associated with the user existing at the point of access,

copying, if there is no such control point at the point of access, the control point to the point of access,

activating the control point, and

connecting the control point with a device, such that the user can access services from the device in dependence of the rights granted to him.

According to a third aspect of the present invention, this object is also achieved by an apparatus for creating a control point associated with a user in a computing environment having a networking connectivity model and arranged to:

generate a control point identity for the user based on a public key associated with the user,

provide at least basic control point functionalities, and

store the control point identity and the functionalities as a control point such that the user can operate any device he is allowed to in the computing environment from any physical entity where the control point is enabled.

According to a fourth aspect of the present invention, the object is also achieved by an apparatus for accessing services provided by a device in a computing environment having a networking connectivity model and arranged to:

identify a user wanting to access services at a point of access for the user to the computing environment by using a control point identifier,

determine if there is a control point associated with the user existing at the point of access,

copy, if there is no such control point at the point of access, the control point to the point of access,

activate the control point, and

connect the control point with a device, such that the user can access services from the device in dependence of the rights granted to him.

According to a fifth aspect of the present invention, the object is also achieved by a network of computing devices using a networking connectivity model and comprising:

an apparatus for creating a control point associated with a user and arranged to:
generate a control point identity for the user based on a public key associated with the user,
provide at least basic control point functionalities, and
store the control point identity and the functionalities as a control point such that the user can operate any device he is allowed to in the computing environment from any physical entity where the control point is enabled, and

an apparatus for accessing services provided by a device and arranged to:
identify a user wanting to access services at a point of access for the user to the computing environment by using a control point identifier,
determine if there is a control point associated with the user existing at the point of access,
copy, if there is no such control point at the point of access, the control point to the point of access,
activate the control point, and
connect the control point with a device, such that the user can access services from the device in dependence of the rights granted to him.

According to a sixth aspect of the present invention, this object is also achieved by a computer program product for creating a control point associated with a user in a computing environment having a networking connectivity model, comprising a computer readable medium having thereon:

computer program code means, to make the computer execute, when said program is loaded in the computer:
generate a control point identity for the user based on a public key associated with the user,
provide at least basic control point functionalities, and
store the control point identity and the functionalities as a control point such that the user can operate any device he is allowed to in the computing environment from any physical entity where the control point is enabled.

According to a seventh aspect of the present invention, this object is also achieved by a computer program product for accessing services provided by a device in a computing environment having a networking connectivity model, comprising a computer readable medium having thereon:

computer program code means, to make the computer execute, when said program is loaded in the computer:
identify a user wanting to access services at a point of access for the user to the computing environment by using a control point identifier,
determine if there is a control point associated with the user existing at the point of access,
copy, if there is no such control point at the point of access, the control point to the point of access,
activate the control point, and
connect the control point with a device, such that the user can access services from the device in dependence of the rights granted to him.

According to an eight aspect of the present invention, this object is furthermore achieved by a computer program element for creating a control point associated with a user in a computing environment having a networking connectivity model, said computer program element comprising:

computer program code means, to make the computer execute, when said program element is loaded in the computer:
generate a control point identity for the user based on a public key associated with the user,
provide at least basic control point functionalities, and
store the control point identity and the functionalities as a control point such that the user can operate any device he is allowed to in the computing environment from any physical entity where the control point is enabled.

According to a ninth aspect of the present invention, this object is also achieved by a computer program element for accessing services provided by a device in a computing environment having a networking connectivity model:

computer program code means, to make the computer execute, when said program element is loaded in the computer:
identify a user wanting to access services at a point of access for the user to the computing environment by using a control point identifier,
determine if there is a control point associated with the user existing at the point of access,
copy, if there is no such control point at the point of access, the control point to the point of access,
activate the control point, and
connect the control point with a device, such that the user can access services from the device in dependence of the rights granted to him.

Claims 2, 3 and 4 are directed towards storing the control point in different locations.

Claim 9 is directed towards registering a control point at a security console for accessing a device.

Claims 10 and 11 are directed towards different ways of granting access to a control point.

The present invention has the advantage of allowing differentiated type of access to a device for a user in a computing environment having a networking connectivity model. The access is furthermore not dependent of the entity via which a user accesses a device, which allows a higher degree of freedom for the user. At the same time the connectivity model does not have to be changed. The invention is furthermore easy to implement by just providing some additional software in addition to the one who already exists.

The general idea behind the invention is thus to create a control point in a computing environment having a networking connectivity model that is associated with the user and not the entity through which access to a device is obtained. Such a control point can then be used for accessing a device anywhere in the environment.

These and other aspects of the invention will be apparent from and elucidated with reference to the embodiments described hereinafter.

The present invention will now be explained in more detail in relation to the enclosed drawings, where

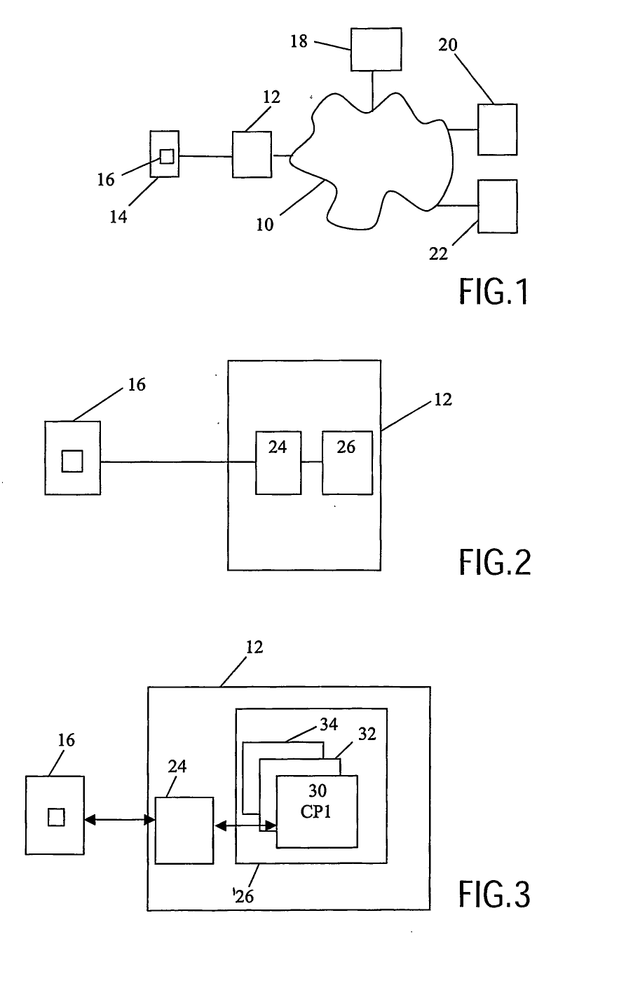

FIG. 1 shows a block schematic of a number of physical devices connected in a network,

FIG. 2 shows a block schematic of an apparatus for creating and accessing a control point according to the invention,

FIG. 3 shows another block schematic of an apparatus for creating and accessing a control point according to the invention,

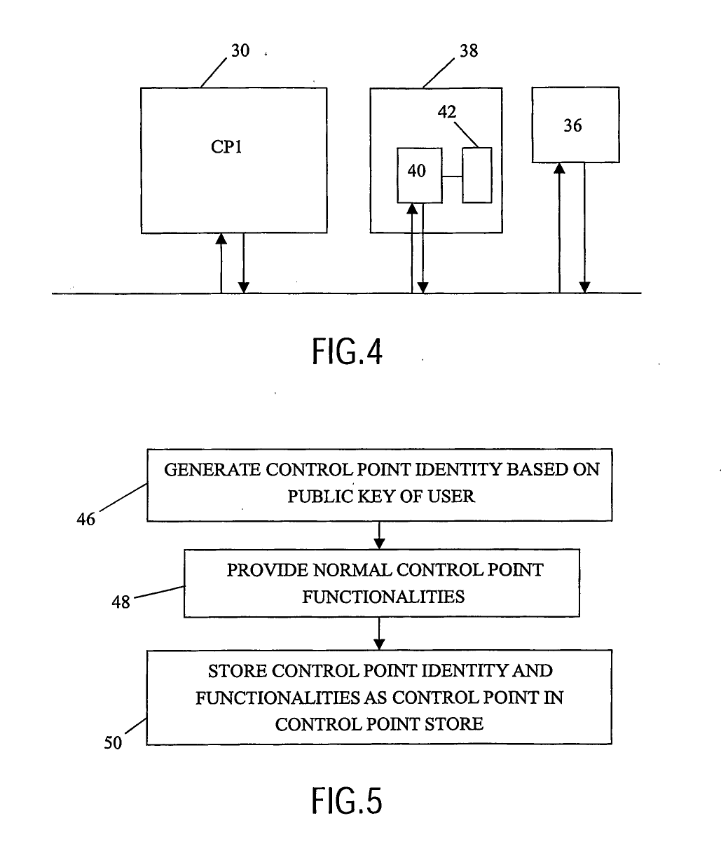

FIG. 4 shows a block schematic of a control point, a device and security console,

FIG. 5 shows a flow chart of a method of creating a control point according to the invention,

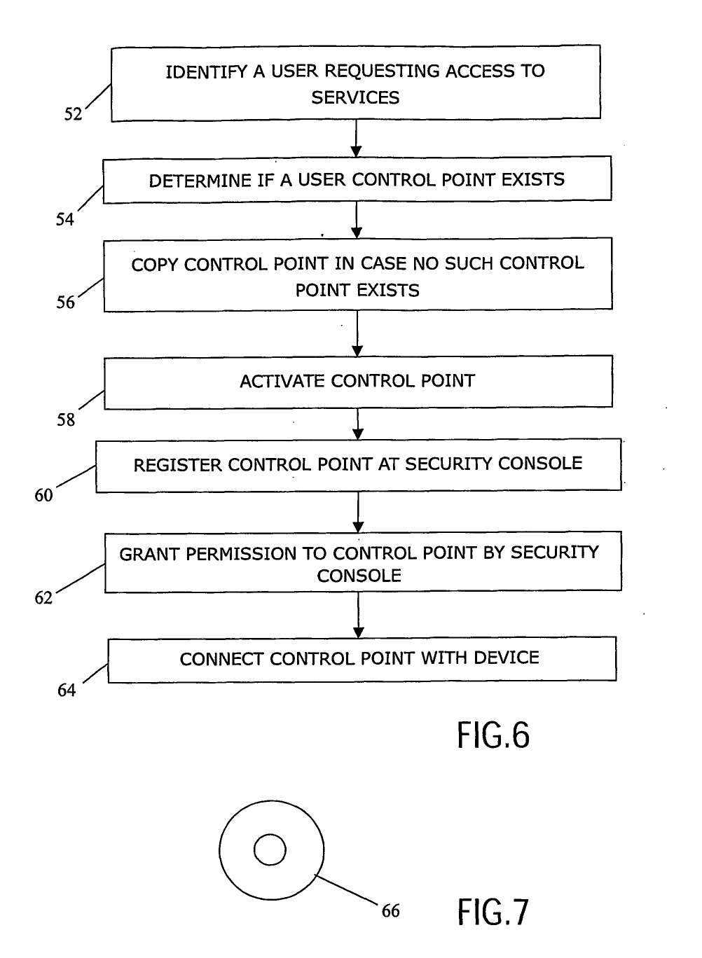

FIG. 6 shows a flow chart of a method of accessing services according to the invention, and

FIG. 7 shows a computer readable medium in the form of a CD ROM disc for storing of program code for performing the invention.

FIG. 1 shows a schematic drawing of a computer network 10, where the invention can be provided. The network is in one embodiment a home network in which different services can be provided. Because of this the network includes a number of physical entities 12, 18, 20 and 22, of which at least some provide different services, like for instance MP3 player, web radio, DVD player etc. To a first of the entities 12 is connected a smart card reader 14 in which a smart card 16 has been inserted. The smart card 16 belongs to a user of the system and includes private and public encryption keys for use in identifying and granting access to the user. Networking is enabled by the connectivity model or standard UPnP (Universal Plug and Play) and access to different devices is enabled through the security definitions of that standard. The network is here fixed, but it is equally as well possible that it is wireless.

FIG. 2 shows a block schematic of the smart card 16 connected to an apparatus 12 for creating and accessing control points and comprising a control point creation and accessing unit 24 to which unit is connected a control point store 26.

FIG. 3 shows another block schematic of the smart card 16 connected to the apparatus 12 for creating and accessing control points. Here the smart card 16 is communicating with the control point creation and accessing unit 24, which is connected to the control point store 26, which includes a first control point 30 as well as a second and third control point 32 and 34. The apparatus 12 can be split into two separate apparatuses, one for creating and one for accessing a control point, and can furthermore be provided in different physical entities. For the sake of clarity they are here provided in the one and same entity though.

The different entities in the network of FIG. 1 all have different services they provide like playing of MP3 files, providing Web radio, video, DVD or other types of media services. It is however possible that one entity can provide several types of services. The different services provided are furthermore controlled by using the standard UPnP (Universal Plug and Play). FIG. 4 schematically shows the general functioning of UPnP. FIG. 4 therefore shows a block schematic of different functional entities, which communicate in a UPnP system, where a first control point 30 is communicating with a device 38 having an action control unit 40 and an action control list 42. Also a security console 36 is included. All these entities can and are communicating with each other. It should furthermore be realized that these entities can be provided in one and same physical entity, but they can just as well be provided in different physical entities. The device 38 according to UPnP has a number of services it provides in a physical entity. The control point 30 in the system can then try to access these services provided by the device 38. However the device 38 only grants access to a control point in dependence of settings made in relation to that control point in an action control list (ACL) 42. The security console 36, which can be seen as the owner of the device, has made these settings. In order for the control point 30 to get access to the functionalities of the device 38, it has to register with the security console 36. The security console 36 is controlled by the owner of the device, which can be the owner of the whole network. When the control point 30 therefore wants to access the device 38, it first registers with the security console 36, which then registers the rights granted to the control point in the ACL 42 of the device 38 in question. Thereafter the control point 30 can control the device 38 according to the settings made in the ACL 42. In this way security is provided in the system in that a control point can only access the services for which the security console has granted rights. Here it should be realized that the device is provided in one of the entities shown in FIG. 1, for instance a second entity 22, whereas the control point 30 can be provided in the same entity or in another of the entities shown in FIG. 1. Similarly the security console 36 can be provided in the same entity, but it can also be provided in another of the entities shown in FIG. 1. The security console 36 can furthermore set up the different rights for several devices.

Traditionally control points have been associated with different physical entities, which means that in FIG. 1, the first entity 12 would have one control point, a second entity 18 another control point, a third entity 20 yet another control point and a fourth entity 22 another control point. This means that in a known system, any user trying to access a service through one entity via a control point of that entity, would get access to all the services allowed to that entity via that control point. This is a problem in that the rights to access should be more linked to the user than the entity trying to access a service. The same entity might be used for accessing the same service by different users and it might not be desirable at all that these different users get access to the same service or to the same services in the same degree.

One way of differentiating between users on a device could then be to have only one control point entity for a device and have credentials per user in the entity where the control point is provided. This would also mean that the entity having the control point manages the access rights. Access rights to a device would then be handled through using logical or-operations for the access rights of the individual users.

There are a few problems with this type of solution. It is difficult to provide conditional rights based on logical or-operations from a security console and then the entity where the control point is provided would now govern access rather than the security console, which would change and complicate the access management model used in UPnP.

In order to solve this, the present invention proposes to link a control point to a user.

How this can be done according to a first aspect of the present invention will now be described in relation to FIGS. 1, 2, 4 and 5, which latter figure shows a flow chart of a method of creating a control point according to the invention. A user is first registered in the system. In order to do this a new control point associated with the user is created. This is done through the user using the first entity 12 and inserting his smart card 16 in the smart card reader 14 connected to the first entity 12. The first entity therefore is provided with a control point creation and accessing unit 24, which is arranged to create the new control point. The control point creation and accessing unit 24 therefore creates a control point identifier, which is based on the public key of the user and normally by making a hash of the public key, which key is provided to this control point creating unit by the user from his smart card, step 46. Thereafter the control point creation and accessing unit 24 provides the control point with normal control point functionalities such as for being able to identify and control devices as well as to subscribe to events from different devices, step 48. The control point creation and accessing unit 24 then stores the control point identity and the functionalities as a control point associated with the user in the control point store 26 in the first entity 12, step 50. It should here be realized that a control point creation and accessing unit can be provided in any of the entities, provided they have a smart card reader. Likewise the control point store can be provided in any of the entities or a copy being made to all entities. There can furthermore be a special server where control points are stored, which the entity through which a user wants to control some device contacts to find the control point in question. It is also possible that the control point is stored on the actual smart card of the user. The control point identifier should however also be stored on the smart card of the user.

A second aspect of the present invention will now be described in relation to FIGS. 1, 3, 4 and 6, where the latter shows a flow chart of a method of accessing services according to the present invention. When a control point 30 thus has been registered and a user later wants to access some device, which can take place from any of the entities of the system allowing access to users, the user gets in contact with the control point creation and accessing unit 24 using his smart card 16 and the control point identifier. The first entity 14 is thus here the point of access for the user to the network. He can then log in to the network using standard login procedures using login name and password. The control point creation and accessing unit 24 therefore identifies a request for access to services, step 52. The control point creation and accessing unit 24 then looks in the control point store 26 and identifies if a control point exists, step 54. If it does not it is copied to the entity from a store somewhere else in the network, for instance in a control point server, step 56. Thereafter the control point creation and accessing unit 24 activates the control point 30 for the user so that he can discover and access different services of the devices in the network, step 58. If the user then wants to access some or any of the devices, which devices can be found via a discovery phase, the control point 30 is then made to register with the security console 36 associated with the device 38, with which the user wants to get in touch, step 60, which has been outlined above in relation to FIG. 4. The security console 36 then grants access to the control point 30 in a known way, step 62, which in this embodiment is done through updating the action control list 42 of the device 38 in question. Thereafter the control point 30 is connected to the device 38 for enabling access, step 64.

The control point creation and accessing unit is preferably provided in the form of one or more processors together with corresponding program memory for containing the program code for performing the methods according to the invention The program code can also be provided on a computer program product, of which one is shown in FIG. 7 in the form of a CD ROM disc 66. This is just an example and various other types of computer program products are just as well feasible. The program code can furthermore be downloaded to an entity or the smart card from a server, perhaps via the Internet. Another alternative is that the program code is stored on the smart card.

It is possible that the entity in question from where the user is trying to access a device does not have any control point accessing unit or control point store. It is then possible that the user in this case can perform a remote login to an entity having such a control point accessing unit and access to a control point store. In this case the user logs in to a login server of the system.

It is furthermore possible that the identification and verification of user can be made according to biometrics information instead of via an ordinary login procedure using login name and password. This biometrics information can be based on showing the eye.

In the above-described embodiments of the present invention rights were granted to a control point by entries in an ACL list of a device. It is just as well possible to provide these rights in the form of a ticket, which is sent to the control point and stored there. When accessing a device, the control point then presents this ticket to the device instead of the device reading the ACL list.

The present invention thus provides a control point, which is directly associated with the user and not the entity from which he tries to get access to a device. Therefore it is easy for an owner of the device to differentiate access between users using the same interface. It is furthermore implemented with small additional costs and efforts without having to change the UPnP standard.

The invention is thus only to be limited by the following claims.

1. Method of creating a control point (30) associated with a user in a computing environment having a networking connectivity model and comprising the steps of:
generating a control point identity for the user based on a public key associated with the user, (step 46),
providing at least basic control point functionalities, (step 48), and
storing the control point identity and the functionalities as a control point (30), (step 50), such that the user can operate any device (38) he is allowed to in the computing environment from any physical entity (12, 18, 20, 22) where the control point is enabled.

2. Method according to claim 1, wherein the control point is stored on a server that an entity through which a user can access a device can reach.

3. Method according to claim 1, wherein the control point is stored on a smart card (16) of the user.

4. Method according to claim 1, wherein a replica of the control point is stored in each device the user can be allowed to control.

5. Method according to claim 1, wherein the connectivity model is Universal Plug and Play.

6. Method of accessing services provided by a device (38) in a computing environment having a networking connectivity model and comprising the steps of:
identifying a user wanting to access services at a point of access (12) for the user to the computing environment by using a control point identifier, (step 52),
determining if there is a control point (30) associated with the user existing at the point of access, (step 54),
copying, if there is no such control point at the point of access, the control point to the point of access, (step 56),
activating the control point, (step 58), and
connecting the control point with a device (38), (step 64), such that the user can access services from the device in dependence of the rights granted to him.

7. Method according to claim 6, wherein the step of identifying comprises performing authentication of the user using the public key and a secret key of the user.

8. Method according to claim 6, wherein the step of copying comprises copying the control point from a known user control point store.

9. Method according to claim 6, further comprising the steps of:
registering the control point (30) at a security console (36) using the control point identifier, (step 60), and
granting permission to the control point regarding at least one device (38) from the security console, (step 62), such that a user can access services of the device via the control point.

10. Method according to claim 9, wherein the step of granting permission comprises storing the control point identifier in an action control list associated with the device in question.

11. Method according to claim 9, wherein the step of granting permission comprises providing the control point with a ticket to be used for accessing services of the device.

12. Method according to claim 9, further comprising the step of accessing the services using access rights provided by a security console (36).

13. Apparatus (12) for creating a control point (30) associated with a user in a computing environment having a networking connectivity model and arranged to:
generate a control point identity for the user based on a public key associated with the user,
provide at least basic control point functionalities, and
store the control point identity and the functionalities as a control point (30) such that the user can operate any device he is allowed to in the computing environment from any physical entity where the control point is enabled.

14. Apparatus (12) for accessing services provided by a device (38) in a computing environment having a networking connectivity model and arranged to:
identify a user wanting to access services at a point of access (12) for the user to the computing environment by using a control point identifier,
determine if there is a control point (30) associated with the user existing at the point of access,
copy, if there is no such control point at the point of access, the control point to the point of access,
activate the control point, and
connect the control point with a device (38), such that the user can access services from the device in dependence of the rights granted to him.

15. Network of computing devices using a networking connectivity model and comprising:
an apparatus (12) for creating a control point (30) associated with a user and arranged to:
generate a control point identity for the user based on a public key associated with the user,
provide at least basic control point functionalities, and
store the control point identity and the functionalities as a control point (30) such that the user can operate any device (3 8) he is allowed to in the computing environment from any physical entity (12, 18, 20, 22) where the control point is enabled, and
an apparatus (12) for accessing services provided by a device and arranged to:
identify a user wanting to access services at a point of access (12) for the user to the computing environment by using a control point identifier,
determine if there is a control point associated with the user existing at the point of access,
copy, if there is no such control point at the point of access, the control point to the point of access,
activate the control point, and
connect the control point with a device (38), such that the user can access services from the device in dependence of the rights granted to him.

16. Computer program product (66) for creating a control point associated with a user in a computing environment having a networking connectivity model, comprising a computer readable medium having thereon:
computer program code means, to make the computer execute, when said program is loaded in the computer:
generate a control point identity for the user based on a public key associated with the user,
provide at least basic control point functionalities, and
store the control point identity and the functionalities as a control point such that the user can operate any device he is allowed to in the computing environment from any physical entity where the control point is enabled.

17. Computer program product (66) for accessing services provided by a device in a computing environment having a networking connectivity model, comprising a computer readable medium having thereon:
computer program code means, to make the computer execute, when said program is loaded in the computer:
identify a user wanting to access services at a point of access for the user to the computing environment by using a control point identifier,
determine if there is a control point associated with the user existing at the point of access,
copy, if there is no such control point at the point of access, the control point to the point of access,
activate the control point, and
connect the control point with a device, such that the user can access services from the device in dependence of the rights granted to him.

18. Computer program element for creating a control point associated with a user in a computing environment having a networking connectivity model, said computer program element comprising:
computer program code means, to make the computer execute, when said program element is loaded in the computer:
generate a control point identity for the user based on a public key associated with the user,
provide at least basic control point functionalities, and
store the control point identity and the functionalities as a control point such that the user can operate any device he is allowed to in the computing environment from any physical entity where the control point is enabled.

19. Computer program element for accessing services provided by a device in a computing environment having a networking connectivity model:
computer program code means, to make the computer execute, when said program element is loaded in the computer:
identify a user wanting to access services at a point of access for the user to the computing environment by using a control point identifier,
determine if there is a control point associated with the user existing at the point of access,
copy, if there is no such control point at the point of access, the control point to the point of access,
activate the control point, and
connect the control point with a device, such that the user can access services from the device in dependence of the rights granted to him.
